(19) United States
(12) Patent Application Publication
(10) Pub. No.: US 2014/0166203 A1
(43) Pub. Date: Jun. 19, 2014

(54) BLOCKING DEVICE, SEALANT CURING DEVICE, AND SEALANT CURING METHOD

(71) Applicant: Meina Zhu, Shenzhen (CN)

(72) Inventor: Meina Zhu, Shenzhen (CN)

(73) Assignee: SHENZHEN CHINA STAR OPTOELECTRONICS TECHNOLOGY CO., LTD, Shenzhen, Guangdong (CN)

(21) Appl. No.: 13/813,657

(22) PCT Filed: Dec. 21, 2012
(86) PCT No.: PCT/CN2012/087178

§ 371 Date: Feb. 1, 2013

(30) Foreign Application Priority Data
Dec. 14, 2012 (CN) 201210544651.8

(51) Int. Cl. G02F 1/1339; G02F 1/13

(52) U.S. Cl. CPC G02F 1/1339; G02F 1/1303
USPC 156/275.5; 156/379.6; 359/361

(57) ABSTRACT

The present disclosure provides a blocking device, which includes a blocking plat having a blocking pattern and transparent areas and an electromagnetic suction unit for sucking the blocking plate. In the embodiment, with the electromagnetic suction unit sucking the blocking plate, the requirements about the smoothness and cleanness of the surface of the blocking plate are decreased to reduce the manufacturing cost and maintaining cost of the sealant curing machine. Additionally, the blocking plate is more stably sucked.

### BACKGROUND

1. Technical Field

The present disclosure relates to liquid crystal displaying technologies, and particularly, to a blocking device, a sealant curing machine, and a sealant curing method.

2. Description of Related Art

A liquid crystal panel generally includes two transparent substrate and liquid crystals sealed between the two substrates. In the manufacturing process of the liquid crystal panel, the liquid crystals are filled and sealed between the transparent substrates to form a number of liquid crystal cells between the two substrates. The liquid crystal cells are sealed between the two substrates by a sealant which is cured by ultraviolet light to form the liquid crystal panel.

In a PSVA (Polymer Stabilized Vertical Alignment) type of liquid crystal display, a number of reactive monomers are mixed with the liquid crystal layer between the two substrates, and a polyimide layer is coated on the surface of each substrate to be the alignment material. When applying voltage to the substrates and irradiating the substrates with ultraviolet light, phase separation occurs between the reactive monomers and liquid crystal molecules to create polymers on the alignment material of the substrates. Due to the interactions between the polymers and the liquid crystal molecules, the liquid crystal molecules can be arranged along the direction of the polymer molecules, thus, the liquid crystal molecules can have pre-tilt angles.

Since the reactive monomers mixed with the liquid crystals of the PSVA type of liquid crystal display are caused to react after being irradiated by ultraviolet light, when the sealant of the PSVA type of liquid crystal display is cured, a blocking device is used for covering the area corresponding to the liquid crystals.

The blocking device is generally a metal layer coated on a piece of glass. The metal layer then is etched to form predetermined patterns. The blocking device is then vacuum sucked by using a quartz rod. The blocking device is placed between ultraviolet light lamps and the liquid crystal panel for partly blocking the ultraviolet light to prevent the liquid crystal layer of the liquid crystal panel from being irradiated by the ultraviolet light. Meanwhile, the ultraviolet light is capable of passing through the blocking device to irradiate the sealant to cure the sealant. However, since the patterns of the blocking device are formed on a piece of glass, and the quartz rod is made of quartz, both the glass and quartz are hard material. Thus after the blocking device and the quartz rod sucked together by vacuum, the surfaces of the blocking device and the quartz rod are required to be smooth and clean, and the process of the quartz rod is required to be precise, which causes the high price of the quartz rod. Additionally, keeping the two hard objects contacting each other by vacuum is unstable.

### SUMMARY

The present disclosure provides a blocking device, a sealant curing machine, and a sealant curing method, which can allow for a stable suction of the blocking device and reduce the manufacturing cost and maintaining cost of the sealant curing machine.

The blocking device provided in the present disclosure includes: a blocking plat having a blocking pattern and transparent areas; and an electromagnetic suction unit for sucking the blocking plate.

Preferably, an area of the blocking pattern is equal to that of a displaying area of a liquid crystal panel, and a shape of the blocking pattern is the same as that of the displaying area of the liquid crystal panel.

Preferably, the electromagnetic suction unit includes a suction portion for sucking the blocking plate, an electrical connection portion connected to the suction portion, and a lead winding around the electrical connection portion.

Preferably, after a voltage is applied to the lead, the lead magnetizes the suction portion of the electromagnetic suction unit, the suction portion and the blocking pattern of the blocking plate are attractive to each other; after the voltage is stopped being applied to the lead, the suction portion of the electromagnetic suction unit is demagnetized, and the blocking plate is separated from the electromagnetic suction unit due to its own gravity.

Preferably, the suction portion of the electromagnetic suction unit is made of soft steel.

Preferably, the blocking pattern of the blocking plate is made of original magnet.

The sealant curing machine provided in the present disclosure includes: a number of ultraviolet light sources, and a blocking device. The blocking device includes a blocking plat having a blocking pattern and transparent areas; and an electromagnetic suction unit for sucking the blocking plate.

Preferably, the electromagnetic suction unit includes a suction portion for sucking the blocking plate, an electrical connection portion connected to the suction portion, and a lead winding around the electrical connection portion.

Preferably, after a voltage is applied to the lead, the lead magnetizes the suction portion of the electromagnetic suction unit, the suction portion and the blocking pattern of the blocking plate are attractive to each other; after the voltage is stopped being applied to the lead, the suction portion of the electromagnetic suction unit is demagnetized, and the blocking plate is separated from the electromagnetic suction unit due to its own gravity.

Preferably, the suction portion of the electromagnetic suction unit is made of soft steel.

Preferably, the blocking pattern is made of original magnet.

Preferably, an area of the blocking pattern is equal to that of a displaying area of a liquid crystal panel, and a shape of the blocking pattern is the same as that of the displaying area of the liquid crystal panel.

Preferably, the sealant curing machine further includes a guiding track, one end of the electrical connection portion of the electromagnetic suction unit is locked in the guiding track and the electromagnetic suction unit is capable of sliding along the guiding track.

The sealant curing method provided in the present disclosure includes: applying a voltage an electromagnetic suction unit to allow the electromagnetic suction unit to suck a blocking plate; and turning on at least one ultraviolet light source such that ultraviolet light can pass through the blocking plate to irradiate a sealant and further to cure the sealant.

Preferably, the step of applying a voltage an electromagnetic suction unit to allow the electromagnetic suction unit to suck a blocking plate includes:
applying the voltage to a lead winding around an electrical connection portion of the electromagnetic suction unit to magnetize a suction portion of the electromagnetic suction unit; and
sucking a blocking pattern of the blocking plate by the suction portion of the electromagnetic suction unit such that the blocking plate can be sucked on the electromagnetic suction unit.

Preferably, the sealant curing method further includes the following step after the step of turning on at least one ultraviolet light source such that ultraviolet light can pass through the blocking plate to irradiate a sealant and further to cure the sealant: after the voltage is stopped being applied to the lead, the electromagnetic suction unit is demagnetized to allow the blocking plate to be separated from the electromagnetic suction unit.

In the embodiment, with the electromagnetic suction unit sucking the blocking plate, the requirements about the smoothness and cleanness of the surface of the blocking plate are decreased to reduce the manufacturing cost and maintaining cost of the sealant curing machine. Additionally, the blocking plate is more stably sucked.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view of blocking device in accordance with an embodiment of the present disclosure;

FIG. 2 is a schematic view of a magnetic suction unit of the blocking device;

FIG. 3 is a schematic view of a sealant curing machine in accordance with an embodiment of the present disclosure;

FIG. 4 is a flow chart of a sealant curing method in accordance with a first embodiment of the present disclosure;

FIG. 5 is flow chart of a step of sucking a blocking plate of the sealant curing method; and

FIG. 6 is a flow chart of a sealant curing method in accordance with a second embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

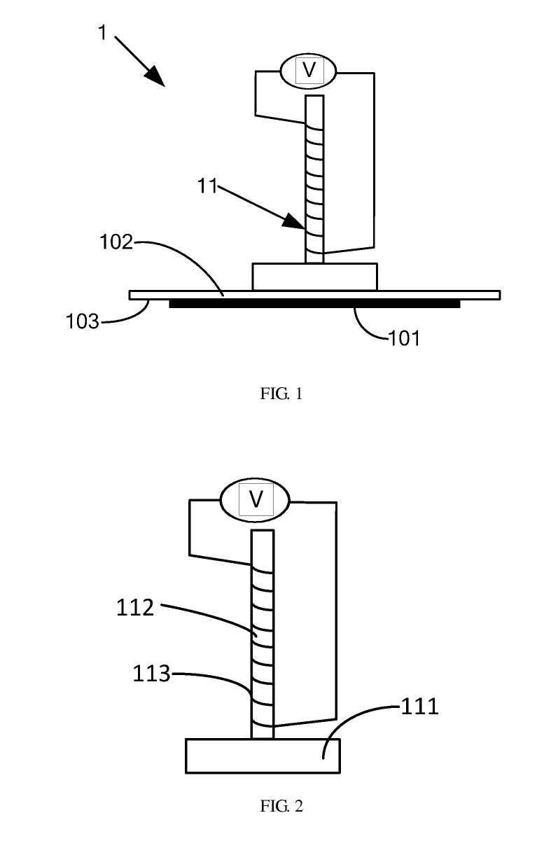

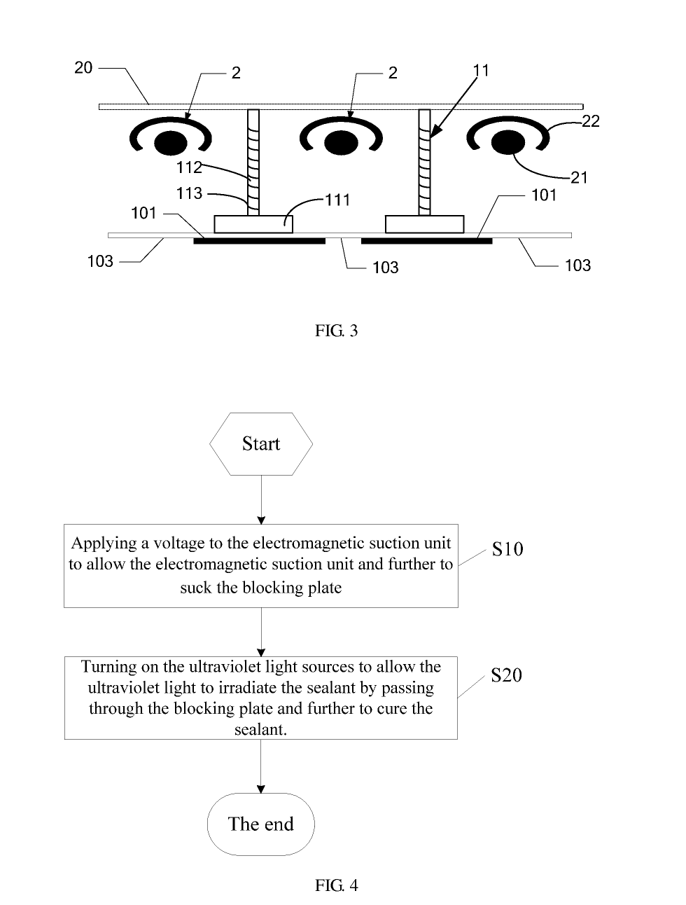

Referring to FIGS. 1 to 3, in which FIG. 1 is a schematic view of blocking device in accordance with an embodiment of the present disclosure, FIG. 2 is a schematic view of a electromagnetic suction unit of the blocking device, and FIG. 3 is a schematic view of a sealant curing machine in accordance with an embodiment of the present disclosure.

The sealant curing machine provided in the embodiment includes a blocking device 1 and a number of ultraviolet light sources 2 for supplying ultraviolet light.

The blocking device 1 is used for partially blocking the ultraviolet light in the curing process of a sealant of a liquid crystal panel, which allows the ultraviolet light to irradiate the sealant of the liquid crystal panel and thus prevents a displaying area of the liquid crystal panel from being irradiated by the ultraviolet light.

The blocking device 1 includes a blocking plate 10 and an electromagnetic sucking unit 11. The blocking plate 10 includes a substrate 102 and a blocking pattern 101 formed on the substrate 102. A part area of the substrate 102 without the blocking pattern 101 formed thereon forms a number of a transparent areas. The blocking pattern 101 is made of original magnet material containing metal such as ion, cobalt, or nickel. The blocking pattern 101 can also be made of alloy containing metal such as ion, cobalt, or nickel. The area of the blocking pattern 101 is equal to that of the displaying area of the liquid crystal panel, and the shape of the blocking pattern 101 is the same as that of the displaying area of the liquid crystal panel.

The electromagnetic suction unit 11 is used for sucking the blocking plate 10. The electromagnetic unit 11 includes a suction portion 111 and an electrical connection portion 112. The electrical connection portion 112 is cylinder shaped with a lead 113 winding around an outer surface of the electrical connection portion 112. The suction portion 111 and the electrical connection portion 112 are made of soft steel. After an outer power source (not shown) applies a voltage onto the lead 113, the lead 113 wound around the electrical connection portion 112 generates a magnetic field which magnetizes the suction portion 111 and the electrical connection portion 112 of the electromagnetic suction unit 11. That is, at this time the suction portion 111 and the electrical connection portion 112 are magnetic. Since the blocking pattern 101 is made of original magnetic material, thus, the suction portion 111 located above the blocking pattern 101 can attract the blocking pattern 101, thereby allowing the electromagnetic suction unit 11 to the suck the blocking plate 10. After the outer power source stops applying the voltage to the lead 113, the magnetic field generated by the lead 113 disappears, and the suction portion 111 and the electrical connection portion 112 are simultaneously demagnetized. At this time, the electromagnetic suction unit 11 cannot suck the blocking plate 10, and the blocking plate 10 is separated from the electromagnetic suction unit 11 due to its own gravity.

The ultraviolet light source 2 includes a ultraviolet light lamp 21 and a lamp chimney 22. The lamp chimney 22 is used for reflecting the ultraviolet light irradiating on the surface thereof to allow the reflected ultraviolet light irradiates the blocking plate 10, which improves the utilization rate of the ultraviolet light.

In the above embodiment, the sealant curing machine further includes a guiding track 20. One end of the electrical connection portion 112 of the electromagnetic suction unit 11 is locked in the guiding track 20. The electromagnetic suction unit 11 is capable of sliding along the guiding track 20 to move the suction portion 111 thereof to an area within the range of the blocking pattern 101 according to the difference of the blocking pattern 101 of the blocking plate 10. In this way, the suction portion 111 is prevented from blocking the transparent areas 103 of the blocking plate 10, and is further prevented from affecting the ultraviolet light irradiation of the sealant, which improves the utilization rate of the ultraviolet light.

During the curing process of the sealant, the blocking device 1 is arranged between the ultraviolet light source 2 and the liquid crystal panel. The blocking plate 10 is sucked by the magnetic force generated by the electromagnetic suction unit 11. The ultraviolet light emitted from the ultraviolet light source 2 partially passes through the transparent areas 103 of the blocking plate 10 to irradiate the sealant of the liquid crystal panel. The ultraviolet light is partially blocked by the blocking pattern 101 of the blocking plate 10 and is prevented from irradiating the displaying area of the liquid crystal panel, which avoids the lost of the pre-orientation function of the monomers due to the irregular polymerization of the monomers which is caused by the pre-irradiation of the liquid crystal layer in the curing process of the sealant.

In the embodiment, with the electromagnetic suction unit 11 sucking the blocking plate 10, the requirements about the smoothness and cleanness of the surface of the blocking plate 10 are decreased to reduce the manufacturing cost and maintaining cost of the sealant curing machine. Additionally, the blocking plate 10 is more stably sucked.

The present disclosure further provides a sealant curing method.

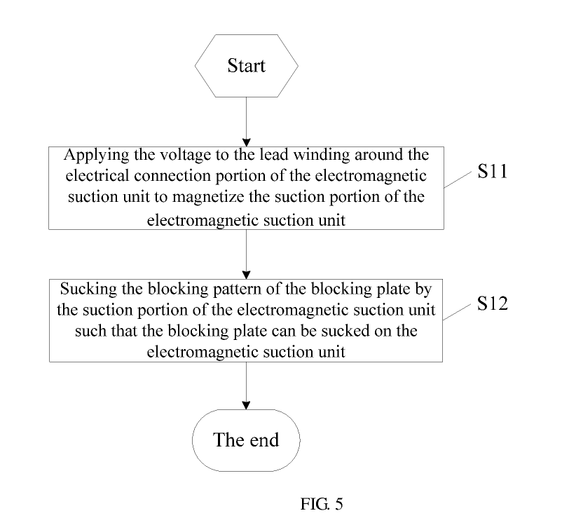

Referring to FIG. 4, which is a flow chart of a sealant curing method in accordance with a first embodiment of the present disclosure.

The sealant curing method uses the sealant curing machine to cure the sealant, including the following steps.

Step S10, applying a voltage to the electromagnetic suction unit to allow the electromagnetic suction unit and further to suck the blocking plate.

In the embodiment, the blocking plate is sucked by the electromagnetic suction unit. After the voltage is applied to the electromagnetic suction unit, the electromagnetic suction unit is magnetized, thus, the electromagnetic suction unit can suck the blocking pattern of the blocking plate to suck the blocking plate.

Step S20, turning on the ultraviolet light sources to allow the ultraviolet light to irradiate the sealant by passing through the blocking plate and further to cure the sealant.

After the electromagnetic suction unit sucks the blocking plate, the ultraviolet light sources are turned on to allow the ultraviolet light source to emit ultraviolet light. The ultraviolet light partially passes through the transparent areas of the blocking plate to irradiate the sealant, thereby curing the sealant. At the same time, the ultraviolet light is partially blocked by the blocking pattern to be prevented from irradiating the displaying area of the liquid crystal panel.

In the embodiment, with the electromagnetic suction unit sucking the blocking plate, the requirements about the smoothness and cleanness of the surface of the blocking plate are decreased to reduce the manufacturing cost and maintaining cost of the sealant curing machine. Additionally, the blocking plate is more stably sucked.

Referring to FIG. 5, which is a flow chart of a step of sucking the blocking plate of the sealant curing method.

In the embodiment, the step S10 includes:
step S11, applying the voltage to the lead winding around the electrical connection portion of the electromagnetic suction unit to magnetize the suction portion of the electromagnetic suction unit; and
step S12, sucking the blocking pattern of the blocking plate by the suction portion of the electromagnetic suction unit such that the blocking plate can be sucked on the electromagnetic suction unit.

In the embodiment, the electromagnetic suction unit includes the suction portion, the electrical connection portion, and the lead winding around the electrical connection portion. After the outer power source (not shown) applies the voltage to the lead, the lead wounding around the electrical connection portion generates a magnetic field to magnetize the suction portion and the electrical connection portion of the electromagnetic suction unit. That is, at this time the suction portion of the electromagnetic suction unit is magnetic. Since the blocking pattern of the blocking plate is made of original material, thus, the suction portion located above the blocking pattern and the blocking pattern are attractive to each other, which allows the electromagnetic suction unit to suck the blocking plate.

With the suction portion and the electrical connection portion of the electromagnetic suction unit, and with the lead winding around the electrical connection portion, after the voltage is applied to the lead, the electromagnetic suction portion is magnetized to suck the blocking pattern of the blocking plate, which allows for a stable suction of the blocking plate.

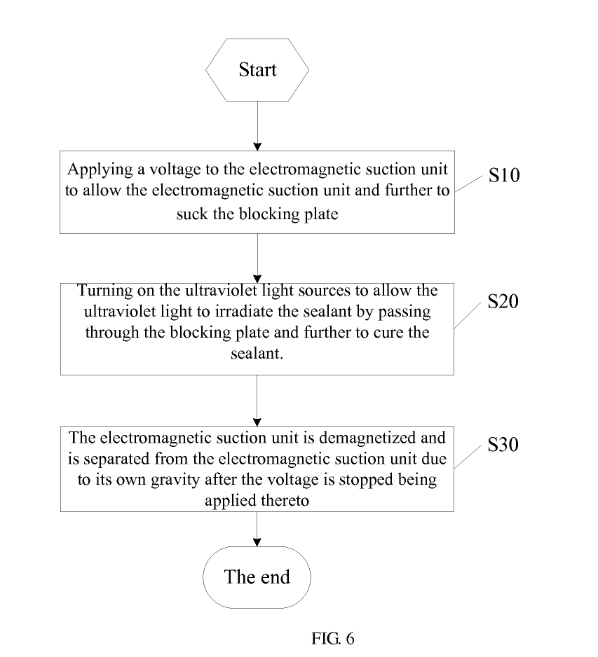

Referring to FIG. 6, which is a flow chart of sealant curing method in accordance with a second embodiment of the present disclosure.

Based on the sealant curing method of the above embodiment, the sealant curing method of the second embodiment further includes step S30 follows the step S20:
step S30, the electromagnetic suction unit is demagnetized and is separated from the electromagnetic suction unit due to its own gravity after the voltage is stopped being applied thereto.

After the sealant curing process is finished, the voltage is no longer applied to the lead, thus, the magnetic field generated by the lead disappears. At this state, the suction portion and the electrical connection portion of the electromagnetic suction unit are simultaneously demagnetized, making the electromagnetic suction portion being incapable of sucking the blocking plate. At this time, the electromagnetic suction unit does not suck the blocking plate to allow the blocking plate to be separated from the electromagnetic suction unit due to its own gravity.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A blocking device, comprising:
a blocking plat having a blocking pattern and transparent areas; and
an electromagnetic suction unit for sucking the blocking plate.

2. The blocking device of claim 1, wherein an area of the blocking pattern is equal to that of a displaying area of a liquid crystal panel, and a shape of the blocking pattern is the same as that of the displaying area of the liquid crystal panel.

3. The blocking device of claim 1, wherein the electromagnetic suction unit comprises a suction portion for sucking the blocking plate, an electrical connection portion connected to the suction portion, and a lead winding around the electrical connection portion.

4. The blocking device of claim 3, wherein after a voltage is applied to the lead, the lead magnetizes the suction portion of the electromagnetic suction unit, the suction portion and the blocking pattern of the blocking plate are attractive to each other; after the voltage is stopped being applied to the lead, the suction portion of the electromagnetic suction unit is demagnetized, and the blocking plate is separated from the electromagnetic suction unit due to its own gravity.

5. The blocking device of claim 4, wherein the suction portion of the electromagnetic suction unit is made of soft steel.

6. The blocking device of claim 1, wherein the blocking pattern of the blocking plate is made of original magnet.

7. A sealant curing machine, comprising:
a number of ultraviolet light sources; and
a blocking device, comprising:
a blocking plat having a blocking pattern and transparent areas; and
an electromagnetic suction unit for sucking the blocking plate.

8. The sealant curing machine of claim 7, wherein the electromagnetic suction unit comprises a suction portion for sucking the blocking plate, an electrical connection portion connected to the suction portion, and a lead winding around the electrical connection portion.

9. The sealant curing machine of claim 8, wherein after a voltage is applied to the lead, the lead magnetizes the suction portion of the electromagnetic suction unit, the suction portion and the blocking pattern of the blocking plate are attractive to each other; after the voltage is stopped being applied to the lead, the suction portion of the electromagnetic suction unit is demagnetized, and the blocking plate is separated from the electromagnetic suction unit due to its own gravity.

10. The sealant curing machine of claim 9, wherein the suction portion of the electromagnetic suction unit is made of soft steel.

11. The sealant curing machine of claim 7, wherein the blocking pattern is made of original magnet.

12. The sealant curing machine of claim 11, wherein an area of the blocking pattern is equal to that of a displaying area of a liquid crystal panel, and a shape of the blocking pattern is the same as that of the displaying area of the liquid crystal panel.

13. The sealant curing machine of claim 7 further comprising a guiding track, one end of the electrical connection portion of the electromagnetic suction unit is locked in the guiding track and the electromagnetic suction unit is capable of sliding along the guiding track.

14. A sealant curing method, comprising:
applying a voltage an electromagnetic suction unit to allow the electromagnetic suction unit to suck a blocking plate; and
turning on at least one ultraviolet light source such that ultraviolet light can pass through the blocking plate to irradiate a sealant and further to cure the sealant.

15. The sealant curing method of claim 14, wherein the step of applying a voltage an electromagnetic suction unit to allow the electromagnetic suction unit to suck a blocking plate comprises:
applying the voltage to a lead winding around an electrical connection portion of the electromagnetic suction unit to magnetize a suction portion of the electromagnetic suction unit; and
sucking a blocking pattern of the blocking plate by the suction portion of the electromagnetic suction unit such that the blocking plate can be sucked on the electromagnetic suction unit.

16. The sealant curing method of claim 15 further comprising the following step after the step of turning on at least one ultraviolet light source such that ultraviolet light can pass through the blocking plate to irradiate a sealant and further to cure the sealant:
after the voltage is stopped being applied to the lead, the electromagnetic suction unit is demagnetized to allow the blocking plate to be separated from the electromagnetic suction unit.
